(19) United States
(12) Patent Application Publication
(10) Pub. No.: US 2008/0171139 A1
(43) Pub. Date: Jul. 17, 2008

(54) METHOD FOR MANUFACTURING MULTILAYER PRINTED WIRING BOARD

(76) Inventors: Yukihiro UENO, Hiroshima (JP); Yuhji TAKAMOTO, Hiroshima (JP)

Correspondence Address: BIRCH STEWART KOLASCH & BIRCH, PO BOX 747, FALLS CHURCH, VA, 22040-0747, US

(21) Appl. No.: 11/972,533

(22) Filed: Jan. 10, 2008

(30) Foreign Application Priority Data
Jan. 11, 2007 (JP) 2007-003832

(51) Int. Cl. B05D 5/12

(52) U.S. Cl. 427/97.1

(57) ABSTRACT

In one embodiment, an inner layer circuit pattern portion and a lead pattern portion are formed, an outer layer base material is prepared, an interlayer adhesive layer to which has been affixed in advance an inner layer separation film is prepared, the interlayer adhesive layer is layered on the outer layer base material, a molded inner layer separation film is formed by molding the inner layer separation film, the molded inner layer separation film is positioned on the lead pattern portion and the outer layer base material is layered on the inner layer base material with interposition of the interlayer adhesive layer, a conductor layer of the outer layer base material is patterned to form an outer layer circuit pattern portion, and the molded inner layer separation film is separated from the inner layer base material to remove the interlayer adhesive layer and the outer layer base material.

### CROSS-REFERENCE TO RELATED APPLICATION

This application claims priority under 35 U.S.C. § 119(a) on Japanese Patent Application No. 2007-003832 filed in Japan on Jan. 11, 2007, the entire contents of which are hereby incorporated by reference.

### BACKGROUND OF THE INVENTION

1. Field of Invention

The present invention relates to a method for manufacturing a printed wiring board used in an electronic device or the like, and more specifically a multilayer printed wiring board having two or more conductor layers, with a portion of an outer layer base material removed and a flexible inner layer base material serving as a lead pattern portion.

2. Related Art

In portable electronic devices such as video cameras and digital cameras, it is necessary to arrange many electronic components in a small internal space, and connect these electronic components by wiring them to each other.

Conventionally, hard printed wiring boards are connected to each other using connectors and cables, but with the object of reliability and controlling impedance of the connections, and reducing volume, multilayer printed wiring boards have been proposed in which a cable portion (a printed wiring board that is flexible and can be bent) and a mounting portion (a hard printed wiring board) are configured as a single printed wiring board.

With respect to cable portions that require flexibility, in order to perform mounting of electronic components or installation to a case, handling is easier when a mounting portion where electronic components are mounted at least has some degree of rigidity, so it is necessary for the multilayer printed wiring board to have both flexibility and rigidity. Thus there are problems such as that the manufacturing process becomes complicated, and stress occurs at a border between a flexible portion and a rigid portion.

Following is a description of, with reference to FIGS. 15 to 20 (Conventional Example 1) and FIGS. 21 and 22 (Conventional Example 2), a method for manufacturing a conventional multilayer printed wiring board that has a portion having flexibility and used as a cable or the like (referred to below as a flexible portion), and a portion that has more conductor layers than the flexible portion, and is rigid compared to the flexible portion, and is a portion where mainly mounting of electronic components are performed (referred to below as a multilayer portion), in a single printed wiring board. Such a multilayer printed wiring board is commonly called a flex-rigid or a rigid-flex printed wiring board.

In order to simplify the drawings and the description, by way of example, a description is given of a multilayer printed wiring board with a configuration in which the multilayer portion has a total of four layers, and the flexible portion has one layer, but the processing procedure is the same in the case of a multilayer printed wiring board with a greater number of layers.

FIG. 15 is a cross-sectional view that shows the overall configuration of an inner layer base material applied in the method for manufacturing a multilayer printed wiring board according to Conventional Example 1.

An inner layer base material 110 is configured with a flexible inner layer insulating base material 111 that serves as an inner layer core, and inner layer conductor layers 112 and 113 formed on both faces of the inner layer insulating base material 111. The inner layer insulating base material 111, for example, is an insulating resin film such as a polyimide, polyether ketone, or crystal polymer. Also, the inner layer conductor layers 112 and 113 are formed by layering, for example, a conductor material (metal layer) such as copper foil on the surface of the inner layer insulating base material 111.

A portion of the inner layer base material 110 is a flexible portion employed as a cable. Also, the inner layer base material 110 is commercially available as double-sided flexible wiring board material.

FIG. 16 is a cross-sectional view that shows an overall state in which a resist mask has been formed in order to form the inner layer circuit pattern portion and the lead pattern portion in the inner layer base material shown in FIG. 15. FIG. 17 is a cross-sectional view that shows an overall state in which an inner layer circuit pattern portion and a lead pattern portion have been formed in the inner layer base material, employing the resist mask shown in FIG. 16.

An etching resist is applied to the surface of the conductor layers 112 and 113 by employing a circuit pattern formation method (such as a photolithography method), thus forming an etching resist 140 that corresponds to a circuit pattern (FIG. 16).

Next, by etching (patterning) the conductor layers 112 and 113 with a suitable etchant, an inner layer circuit pattern 112c, an inner layer circuit pattern 113c, and a lead pattern 112t are formed, and then the etching resist 140 is peeled away (FIG. 17). When copper foil is used for the conductor layers 112 and 113, cupric chloride, ferrous chloride, or the like is employed as the etchant.

The inner layer circuit pattern 112c and the inner layer circuit pattern 113c constitute an inner layer circuit pattern portion Acf. The lead pattern 112t constitutes a lead pattern portion At (flexible portion) extended from the inner layer circuit pattern portion Acf. That is, by patterning the conductor layers 112 and 113 of the inner layer base material 110, the inner layer circuit pattern portion Acf and the lead pattern portion At are formed (inner layer pattern formation step).

In the inner layer circuit pattern portion Acf, an outer layer circuit pattern (conductor layer 122) is formed by layering in a subsequent step, thus configuring a multilayer portion (layered circuit pattern portion Acs/outer layer circuit pattern portion Ace (see FIG. 19)).

The lead pattern 112t is a lead pattern (flexible portion employed as a cable) for making an external connection, and is extended from the inner layer circuit pattern 112c (the inner layer circuit pattern portion Acf). Formed at the tip of the lead pattern 112t is an exposed portion 112tt that acts as a terminal portion/land portion. Also, surface treatment such as metal plating or the like is performed on the exposed portion 112tt in a subsequent step, so that the exposed portion 112tt functions as a connection terminal that is connected to outside. That is, the exposed portion 112tt is a portion drawn out as a connection terminal of the lead pattern portion At of the completed multilayer printed wiring board.

A discarded plate portion Ah that is ultimately cut is disposed around the circumference of the inner layer circuit pattern portion Acf (layered circuit pattern portion Acs) and the lead pattern portion At.

FIG. 18 is a cross-sectional view that shows an overall state in which an insulating protective film has been formed on the inner layer base material shown in FIG. 17.

After an inner layer pattern formation step, a coverlay 114 that serves as an insulating protective film is fastened to conductor layer portions other than the exposed portion 112tt (the inner layer circuit pattern 112c, the inner layer circuit pattern 113c, and the lead pattern 112t).

Ordinarily, the same material as the insulating resin film of the inner layer insulating base material 111, with the same thickness, is used as the coverlay 114. The coverlay 114 includes a coverlay base material 114a and a coverlay adhesive layer 114b. Also, when necessary, a surface treatment such as metal plating or the like is performed on the exposed portion 112tt (terminal/land portion).

FIG. 19 is a cross-sectional view that shows an overall state in which the outer layer base material has been layered on the inner layer base material shown in FIG. 18. FIG. 20 is a plan view that shows the state in FIG. 19 when viewed from above. In FIG. 20, for the sake of a more legible drawing, circuit patterns, resists, holes, and the like are not shown.

Next, an outer layer base material 120, and an interlayer adhesive layer 125 that fastens the outer layer base material 120 to the inner layer base material 110, are prepared. The outer layer base material 120 is configured with an outer layer insulating base material 121 that serves as an outer layer core, and the conductor layer 122 formed on the surface of the outer layer insulating base material 121.

Employed as the outer layer base material 120 is, for example, a single-sided wiring board material that is ordinarily commercially available. In this material, copper foil (the conductor layer 122) is layered on an insulating material (the outer layer insulating base material 121) of glass epoxy or polyimide.

The interlayer adhesive layer 125 is layered on a face where the outer layer base material 120 faces the inner layer base material 110, and with a layering press or the like, the outer layer base material 120 is layered and fastened to the inner layer base material 110 (base material layering step; FIG. 19).

A portion that corresponds to the layered circuit pattern portion Acs in the outer layer base material 120 layered on the inner layer base material 110 becomes the outer layer circuit pattern portion Ace with the formation of an outer layer circuit pattern (not shown) by patterning of the conductor layer 122 (outer layer pattern formation step).

After the base material layering step, applying a multilayer printed wiring board manufacturing method that includes through-hole processing, panel plating, outer layer circuit pattern formation, solder resist formation, silk printing, and surface treatment such as plating or rust-proofing treatment, steps advance until immediately before outer shape processing.

In the multilayer printed wiring board in a completed state, it is necessary that the lead pattern portion At (flexible portion) is exposed to the outside. That is, it is necessary that a portion that corresponds to the lead pattern portion At of the outer layer base material 120 layered on the inner layer base material 110 in the base material layering step is removed prior to completion of the multilayer printed wiring board. Also, the lead pattern portion At has a border position BP of a border with the multilayer portion (layered circuit pattern portion Acs/inner layer circuit pattern portion Acf/outer layer circuit pattern portion Ace). Note that the multilayer portion is harder than the flexible portion, because the inner layer base material 110 and the outer layer base material 120 have been layered.

Accordingly, in order to facilitate removal of the outer layer base material 120 in a region that corresponds to the lead pattern portion At, a separation slit 120g is formed in advance prior to layering at a portion that corresponds to the border position BP of the outer layer base material 120, and the interlayer adhesive layer 125 is removed in advance in the region that corresponds to the lead pattern portion At.

That is, the inner layer base material 110 is not fastened to the outer layer base material 120 in the portion that becomes the flexible portion due to formation of the separation slit 120g and removal of the interlayer adhesive layer 125 in the region corresponding to the lead pattern portion At. Accordingly, by performing outer shape processing (outer circumferential edge formation) of the flexible portion/multilayer portion (multilayer printed wiring board) in an outer shape formation step, which is a subsequent step, it is possible to remove the outer layer base material 120 in a portion that corresponds to the lead pattern portion At.

As shown in FIG. 20, at cutting line DL, outer shape processing is performed (outer shape formation step). The separation slit 120g extends slightly to the outside of the cutting line DL. Thus, when outer shape processing is performed by perforation with a metal die or the like corresponding to the cutting line DL, the outer layer base material 120 is separated into two portions at the separation slit 120g, the two portions being a multilayer portion side and a flexible portion side.

The outer layer base material 120 (outer layer circuit pattern portion Ace) side of the multilayer portion (layered circuit pattern portion Acs) side is fastened to the inner layer base material 110 (inner layer circuit pattern portion Acf) with adhesive, while the outer layer base material 120 of the flexible portion (lead pattern portion At) side is only closely fitted physically with pressure and heat in a step during substrate layering because there is no interlayer adhesive layer 125. The outer layer base material 120 superimposed on the flexible portion (lead pattern portion At) is peeled away with a jig or by hand, and thus the multilayer printed wiring board is completed.

Methods for layering outer layer base material on inner layer base material after slit is formed in advance in order to separate unnecessary outer layer base material are disclosed in, for example, JP H7-106765A, JP H9-331153A, JP 2003-31950A, and JP 2006-210873A.

FIG. 21 is a cross-sectional view that shows an overall state in which an outer layer circuit pattern has been formed by layering the outer layer base material on the inner layer base material, in a method for manufacturing a multilayer printed wiring board according to Conventional Example 2.

Other than Conventional Example 1, a method cited as Conventional Example 2 has been proposed in which a slit is not formed in advance in the outer layer base material. For example, in such a method, after layering the outer layer base material, only the outer layer base material is cut with a laser, or the outer layer base material is mechanically peeled away. When the outer layer base material is mechanically peeled away, the cutting position is likely to become uncertain, so it is known to perform some measure such that the outer layer base material is peeled away at a desired location. Specifically, processing is performed up to the base material layering step shown in FIG. 19 with the same procedure as in Conventional Example 1. Unlike in the case of Conventional Example 1, in Conventional Example 2a separation slit 120g is not formed.

In Conventional Example 2, as a means of assisting cutting of outer layer base material 120, when a conductor layer 122 is patterned to form an outer layer circuit pattern 122c, thus configuring an outer layer circuit pattern portion Ace (outer layer pattern formation step), the conductor layer 122 is patterned so that two border delineating patterns 122cg are formed that sandwich a border position BP. It is also possible to have only any single border delineating pattern 122cg. After the outer layer pattern formation step, processing such as solder resist formation, silk printing, and the like are performed.

FIG. 22 is a plan view that shows, viewed from above, a state in which a cutting slit has been formed after configuring the outer layer pattern portion in FIG. 21. In FIG. 22, for the sake of a more legible drawing, circuit patterns, resists, holes, and the like are not shown.

After the outer layer pattern formation step, a cutting slit 120f is formed by center hole processing performed at the circumference of the flexible portion, except for border position BP of the lead pattern portion At (flexible portion) and the multilayer portion (layered circuit pattern portion Acs/inner layer circuit pattern portion Acf/outer layer circuit pattern portion Ace). Due to formation of the cutting slit 120f, a cutting end portion 122ff (angle portion and end portion) of the outer layer base material 120 corresponding to the end position of the lead pattern portion At is exposed.

The outer layer base material 120 covering the lead pattern portion At is composed of material that is comparatively fragile and can be peeled away, so breaking off or peeling away of the outer layer base material 120 at the border position BP is possible. Accordingly, by peeling away the outer layer base material 120 from the exposed cutting end portion 122ff, it is possible to remove the outer layer base material 120 that corresponds to the lead pattern portion At.

Also, the border delineating pattern 122cg acts as a guide when peeling the outer layer base material 120, and acts such that the outer layer base material 120 is not peeled away at an unintended portion.

After removing the excess portion of the outer layer base material 120, outer shape processing is performed on the flexible portion and the multilayer portion, and thus the multilayer printed wiring board is completed.

Other than Conventional Example 2, methods of peeling outer layer base material of a flexible portion have been proposed. Among these are methods employing half-punching and methods for performing half-groove processing from inside (for example, see JP H5-90756A), methods for cutting from outside during final outer shape processing (for example, see JP H4-34993A), and simple methods in which an adhesive layer is not applied on a flexible portion (for example, see JP H6-216531A, and JP H9-74252A).

Also, methods have been proposed in which, when outer layer base material is comparatively thin, a portion corresponding to the flexible portion is cut out and removed in advance (for example, see JP H6-216537A, JP H8-148835A, and JP 2006-186178A).

Methods have been proposed in which, when outer layer base material is comparatively thick, because of the problem that layer fastening cannot be performed uniformly due to a difference in the thickness of a flexible portion and a multilayer portion, a member that has been cut out and removed or another member is temporarily returned to a hole where the member was removed, and then the member is removed again after layering, or a mold releasing member is sandwiched, or a material having mold releasing properties is used, or the like (for example, see JP H3-290990A, JP H7-50456A, JP H6-216533A, and JP H6-252552A).

Further, methods have been proposed such as sandwiching a double-sided mold releasing material or a self-peeling adhesive between the flexible portion and the outer layer base material (for example, see JP H7-135393A).

Also, methods have been proposed in which a multilayer printed wiring board is formed employing self-releasing adhesive tape (for example, see JP 2006-203155A). Further, JP 2003-115665A described below has been proposed as improved technology.

As is clear from the conventional examples, how to remove outer layer base material that is superimposed on a flexible portion, i.e., how to insure that the outer layer base material and the inner layer base material that constitutes the flexible portion are not fastened, is the most important technological point in the manufacturing process for a multilayer printed wiring board of the flex-rigid type.

As disclosed in Conventional Examples 1 and 2, generally a technique is most widespread in which an interlayer adhesive layer is perforated in advance by die processing or the like. However, with this technique, it is unexpectedly difficult to properly perform die processing without soiling an adhesive face, and there are problems of the sort given below.

(1) The adhesive face is tacky, and has not yet hardened, so trash or dust easily attach to the adhesive face.
(2) When processing is performed with a die, the adhesive face is easily soiled by oil or the like from hands or machinery.
(3) Even if the adhesive face has been protected with mold releasing paper or the like, when that paper is peeled away, it is likely that a peel-away electric charge will occur, or that soiled matter of the mold releasing paper will move to the adhesive face.
(4) It is difficult to perform layering with the position of an adhesive sheet that has undergone hole processing properly matched to that of the inner layer base material.

In other words, there are the problems that after the base material layering step, the likelihood that adhesive properties will decrease, and the likelihood that defects due to debris will occur, are high, and the precision of the position of the flexible portion is reduced.

Also, there is the problem that when slit processing has been performed on the outer layer base material in advance, or when hole processing has been performed, incontinuity occurs in the total thickness at the border of the multilayer portion and the flexible portion, and when performing layer fastening, because layering pressure is uneven, adhesive flows to the flexible portion, for which pressure is lower than for the multilayer pressure, and which has a gap, so that total thickness of the multilayer portion near the flexible portion becomes thinner in a sloped manner, or there is the problem that the adhesive protrudes to the region of the flexible portion, so the outer layer base material is fastened at an unintended portion of the flexible portion and thus the outer layer base material cannot be peeled away. In addition to the problems above, there is also the problem that due to the adhesive protruding in the vicinity of the border of the flexible portion and the multilayer portion, there is a decrease in quality.

Further, an edge of the hole portion (slit portion) functions as a knife during layering, damaging the flexible portion at the border position of the flexible portion and the multilayer portion, and so a circumstance occurs in which the bending properties of the completed multilayer printed wiring board at the flexible portion, in particular anti-flexibility of the flexible portion at the border position of the flexible portion and the multilayer portion, are decreased.

Also, there are the problems that when a slit is formed in advance in the outer layer base material, or when the outer layer base material that corresponds to the flexible portion is removed in advance, in a de-smearing processing performed during through hole or via hole formation, via a slit or a region where the outer layer base material has been removed, inner layer base material in an exposed state or insulating resin base material of the flexible portion is damaged, so that there is a marked reduction in insulation properties, interlayer adhesive strength, flexibility resistance, friction resistance, and the like. In order to avoid these problems, a measure is necessary such as producing, in advance, a metal film that is resistant to de-smearing treatment (see JP 2003-115665A).

Also in the case of a method in which a mold releasing member is sandwiched, much time and effort is required to dispose the mold releasing member at an appropriate position, and it is very difficult to perform control such that the mold releasing member is not displaced during layering, so stable production is difficult.

### SUMMARY OF THE INVENTION

It is an object of the present invention to provide a method for manufacturing a multilayer printed wiring board provided with a flexible inner layer base material having an inner layer circuit pattern portion and a lead pattern portion extended from the inner layer circuit pattern portion, and an outer layer base material having an outer layer circuit pattern portion layered on the inner layer circuit pattern portion; in which an interlayer adhesive layer to which has been affixed in advance an inner layer separation film that has separability from the inner layer base material is layered on the outer layer base material, and the outer layer base material is layered on the inner layer base material with interposition of the molded inner layer separation film formed by molding the inner layer separation film so as to correspond to the lead pattern portion, so the interlayer adhesive layer and the outer layer base material are prevented from being fastened to the inner layer base material in the lead pattern portion, and thus, by removing the inner layer separation film that corresponds to the lead pattern portion, it is possible to easily and precisely remove the interlayer adhesive layer and the outer layer base material that have been layered on the inner layer separation film.

The method for manufacturing a multilayer printed wiring board according to the present invention is a method for manufacturing a multilayer printed wiring board provided with a flexible inner layer base material having an inner layer circuit pattern portion and a lead pattern portion extended from the inner layer circuit pattern portion, and an outer layer base material having an outer layer circuit pattern portion layered on the inner layer circuit pattern portion; the method being provided with an inner layer pattern formation step of patterning a conductor layer of the inner layer base material to form an inner layer circuit pattern of the inner layer circuit pattern portion and a lead pattern of the lead pattern portion, an outer layer base material preparation step of preparing the outer layer base material that will be layered on the inner layer base material, an interlayer adhesive layer preparation step of preparing an interlayer adhesive layer to which has been affixed in advance an inner layer separation film that has releasability from the inner layer base material, an interlayer adhesive layer layering step of layering the interlayer adhesive layer on the outer layer base material, a separation film molding step of forming a molded inner layer separation film by molding the inner layer separation film so as to correspond to the lead pattern portion, a base material layering step of positioning the molded inner layer separation film on the lead pattern portion and layering the outer layer base material on the inner layer base material with interposition of the interlayer adhesive layer, an outer layer pattern formation step of patterning a conductor layer of the outer layer base material layered on the inner layer base material to form the outer layer circuit pattern portion layered corresponding to the inner layer circuit pattern portion, and an outer layer base material removal step of separating the molded inner layer separation film from the inner layer base material to remove the interlayer adhesive layer and the outer layer base material layered on the molded inner layer separation film.

With this configuration, because the outer layer base material, to which has been affixed the molded inner layer separation film molded corresponding to the lead pattern portion, is layered on the inner layer base material, the interlayer adhesive layer and the outer layer base material are prevented from being fastened to the inner layer base material in the lead pattern portion, so by removing the inner layer separation film that corresponds to the lead pattern portion, it is possible to easily and precisely remove the interlayer adhesive layer and the outer layer base material layered on the inner layer separation film.

That is, even if the interlayer adhesive layer and the outer layer base material are not processed in advance, effects on the lead pattern portion in the base material layering step or the outer layer base material removal step by the outer layer base material or the interlayer adhesive layer are eliminated, so the precisely positioned lead pattern portion can be configured with good productivity, and thus it is possible to manufacture, with good productivity, a multilayer printed wiring board having a lead pattern portion with high precision and high bendability. Also, the molded inner layer separation film is formed by molding the inner layer separation film that has been affixed to the interlayer adhesive layer in advance, so a molded inner layer separation film can be formed with good productivity, and it is possible to simplify the production process.

Also, in the method for manufacturing a multilayer printed wiring board according to the present invention, a configuration may be adopted in which in the separation film molding step, the inner layer separation film other than the molded inner layer separation film is removed.

With this configuration, the molded inner layer separation film corresponding to the lead pattern portion can be formed easily and precisely.

Also, in the method for manufacturing a multilayer printed wiring board according to the present invention, a configuration may be adopted in which the molded inner layer separation film is thinner than the interlayer adhesive layer, and has physical properties so as to maintain the releasability in the interlayer adhesive layer layering step, the base material layering step, and the outer layer pattern formation step.

With this configuration, it is possible to layer the inner layer base material and the outer layer base material with good flatness, in a state with the lead pattern portion separated from the interlayer adhesive layer and the outer layer base material, and thus it is possible to form the lead pattern portion precisely and with good productivity.

Also, in the method for manufacturing a multilayer printed wiring board according to the present invention, a configuration may be adopted in which the interlayer adhesive layer and the inner layer separation film are in a sheet-like form layered with each other in advance.

With this configuration, the interlayer adhesive layer and the inner layer separation film can be prepared with good productivity and reliability, and molding of the inner layer separation film can be easily performed.

Also, in the method for manufacturing a multilayer printed wiring board according to the present invention, a configuration may be adopted in which the interlayer adhesive layer is in a form of an adhesive sheet in advance, and the inner layer separation film is a mold releasing material formed in advance on the surface of the adhesive sheet in order to protect the surface of the adhesive sheet in a course of transport.

With this configuration, it is possible to simplify the steps and form the molded inner layer separation film with good productivity.

Also, in the method for manufacturing a multilayer printed wiring board according to the present invention, a configuration may be adopted in which in the separation film molding step, by cutting the inner layer separation film and the interlayer adhesive layer, a cut-in that reaches the outer layer base material is formed at a border of the inner layer circuit pattern portion and the lead pattern portion, and to the outside of an outer shape position of the lead pattern portion other than at the border, and the inner layer separation film is molded at the position of the cut-in.

With this configuration, the molded inner layer separation film corresponding to the lead pattern portion can be formed precisely, and it is possible to precisely and easily remove the outer layer base material and the interlayer adhesive layer.

Also, the method for manufacturing a multilayer printed wiring board according to the present invention may be provided with an outer shape formation step of cutting, at the outer shape position of the lead pattern portion, the inner layer base material and the outer layer base material that have been layered, to form the outer shape of the lead pattern portion.

With this configuration, the molded inner layer separation film is exposed to the edge portion of the outer shape of the molded inner layer separation film, and because the exposed molded inner layer separation film can be easily peeled away from the lead pattern portion, it is possible to form a lead pattern portion precisely and with good productivity.

Also, in the method for manufacturing a multilayer printed wiring board according to the present invention, a configuration may be adopted in which the outer layer base material is broken off at the position of the cut-in of the border.

With this configuration, it is possible to precisely and easily remove the inner layer separation film, the interlayer adhesive layer, and the outer layer base material at the border of the inner layer circuit pattern portion and the lead pattern portion, thus precisely forming a lead pattern portion with strong connecting strength.

Also, in the method for manufacturing a multilayer printed wiring board according to the present invention, a configuration may be adopted in which the interlayer adhesive layer includes epoxy type resin, and the inner layer separation film includes polyimide resin.

With this configuration, it is possible to adopt an inner layer separation film that exhibits stable action.

According to the method for manufacturing a multilayer printed wiring board according to the present invention, an interlayer adhesive layer to which has been affixed in advance an inner layer separation film that has releasability from the inner layer base material is layered on the outer layer base material, and the outer layer base material is layered on the inner layer base material with interposition of the molded inner layer separation film formed by molding the inner layer separation film so as to correspond to the lead pattern portion, so the interlayer adhesive layer and the outer layer base material are prevented from being fastened to the inner layer base material in the lead pattern portion, for which flexibility is required. Thus, by removing the inner layer separation film that corresponds to the lead pattern portion, it is possible to easily and precisely remove the interlayer adhesive layer and the outer layer base material that have been layered on the inner layer separation film, obtaining the effect that it is possible to form, with good productivity, a multilayer printed wiring board having a lead pattern portion with high precision and high reliability.

### BRIEF DESCRIPTION OF THE DRAWINGS

FIG. 1 is a cross-sectional view that shows the overall configuration of an inner layer base material applied in a method for manufacturing a multilayer printed wiring board according to a first embodiment of the present invention.

FIG. 2 is a cross-sectional view that shows an overall state in which an inner layer circuit pattern portion and a lead pattern portion have been formed in the inner layer base material shown in FIG. 1.

FIG. 3 is a cross-sectional view that shows an overall state in which an insulating protective film has been formed on the inner layer base material shown in FIG. 2.

FIG. 4 is a cross-sectional view of an overall state of an outer layer base material prepared for layering on the inner layer base material shown in FIG. 3.

FIG. 5 is a cross-sectional view that shows an overall state of an interlayer adhesive layer prepared as a member that layers the outer layer base material shown in FIG. 4 on the inner layer base material.

FIG. 6 is a cross-sectional view that shows an overall state in which the outer layer base material shown in FIG. 4 and the interlayer adhesive layer shown in FIG. 5 have been layered.

FIG. 7 is a cross-sectional view of an overall state when an inner layer separation film affixed to the outer layer base material in FIG. 6 is cut so as to correspond to the lead pattern portion.

FIG. 8 is a cross-sectional view of an overall state when removing an inner layer separation film other than a molded inner layer separation film formed by cutting the inner layer separation film in FIG. 7.

FIG. 9 is a plan view that illustrates, viewed from above, the state of the molded inner layer separation film viewed through the outer layer base material when the outer layer base material with the molded inner layer separation film formed therein layered on the inner layer base material.

FIG. 10 is a cross-sectional view of an overall arranged state when the outer layer base material with the molded inner layer separation film formed therein has been positioned on the inner layer base material.

FIG. 11 is a cross-sectional view that shows an overall state in which after the positioning in FIG. 10, the outer layer base material has been layered on the inner layer base material.

FIG. 12 is a cross-sectional view that shows an overall state in which a layered circuit pattern portion has been configured by forming an outer layer circuit pattern on the outer layer base material layered on the inner layer base material in FIG. 11.

FIG. 13 is a cross-sectional view that shows an overall state in which a multilayer printed wiring board is completed by forming outer circumferential edges of the layered circuit pattern portion and the lead pattern portion in FIG. 12, and then separating the outer layer base material that corresponds to the lead pattern portion from the inner layer base material.

FIG. 14 is a cross-sectional view that shows an overall state in which the molded inner layer separation film according to the first embodiment is applied to a folding-type multilayer printed wiring board, in a method for manufacturing a multilayer printed wiring board according to a third embodiment of the present invention.

FIG. 15 is a cross-sectional view that shows the overall configuration of an inner layer base material applied in the method for manufacturing a multilayer printed wiring board according to Conventional Example 1.

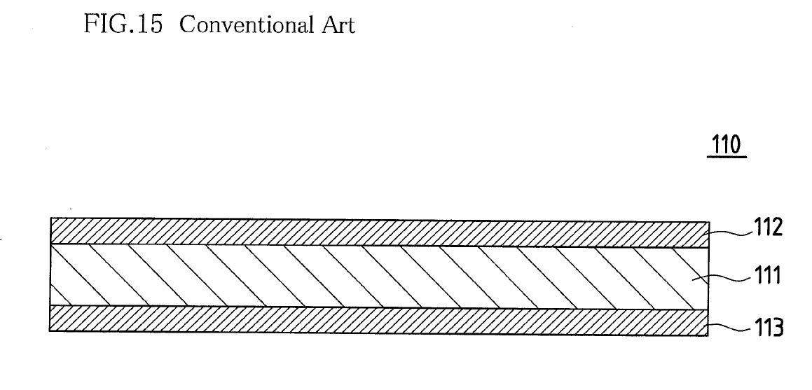

FIG. 16 is a cross-sectional view that shows an overall state in which a resist mask has been formed in order to form the inner layer circuit pattern portion and the lead pattern portion in the inner layer base material shown in FIG. 15.

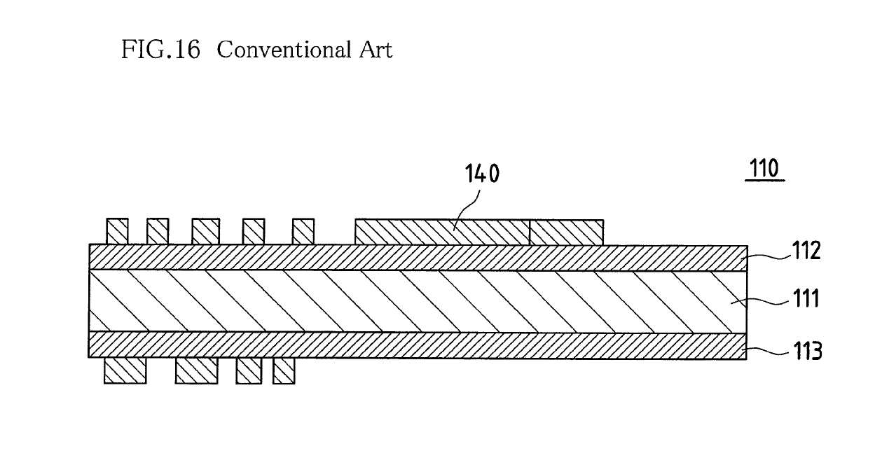

FIG. 17 is a cross-sectional view that shows an overall state in which an inner layer circuit pattern portion and a lead pattern portion have been formed in the inner layer base material, employing the resist mask shown in FIG. 16.

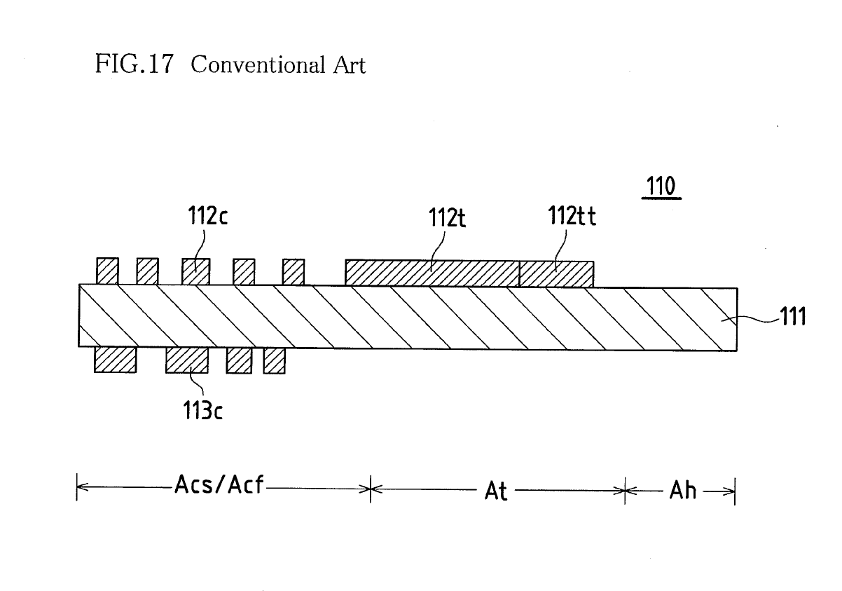

FIG. 18 is a cross-sectional view that shows an overall state in which an insulating protective film has been formed on the inner layer base material shown in FIG. 17.

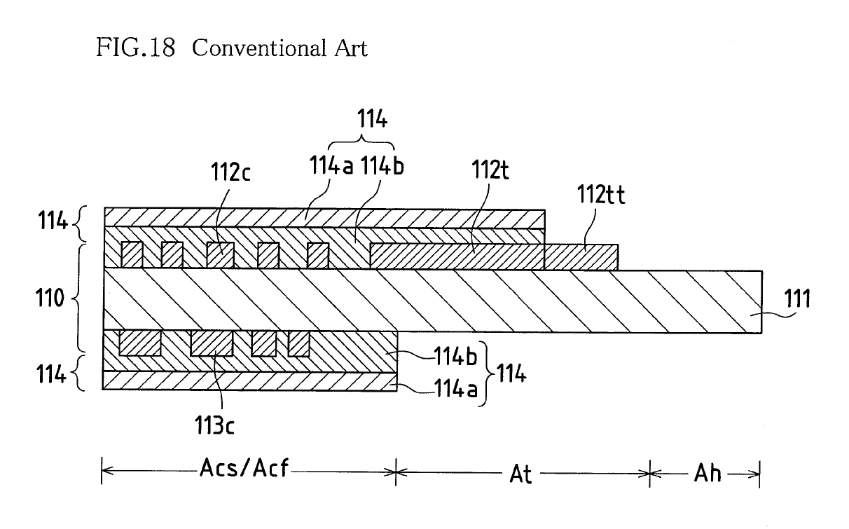

FIG. 19 is a cross-sectional view that shows an overall state in which the outer layer base material has been layered on the inner layer base material shown in FIG. 18.

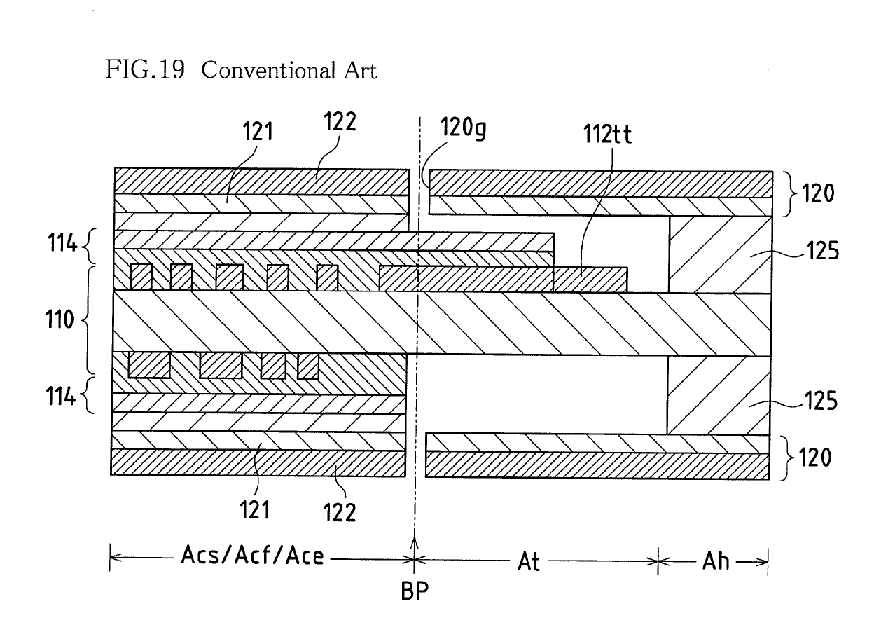

FIG. 20 is a plan view that shows the state in FIG. 19 when viewed from above.

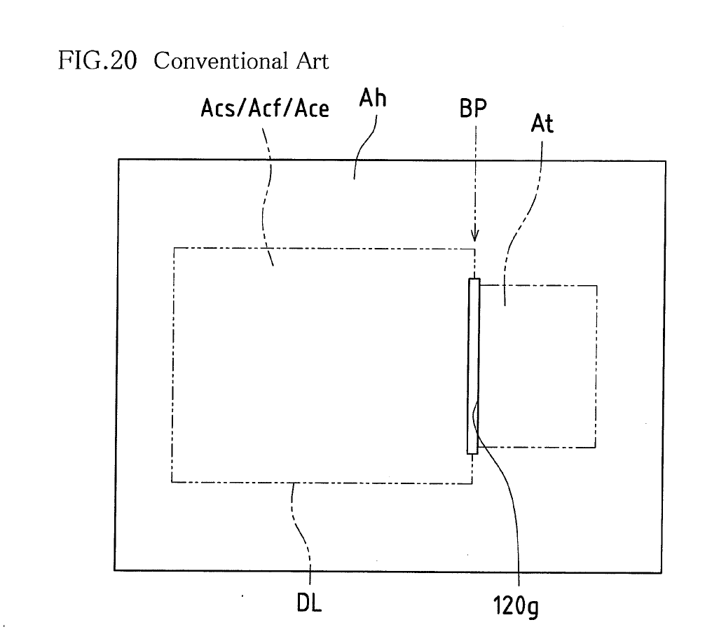

FIG. 21 is a cross-sectional view that shows an overall state in which an outer layer circuit pattern has been formed by layering the outer layer base material on the inner layer base material, in a method for manufacturing a multilayer printed wiring board according to Conventional Example 2.

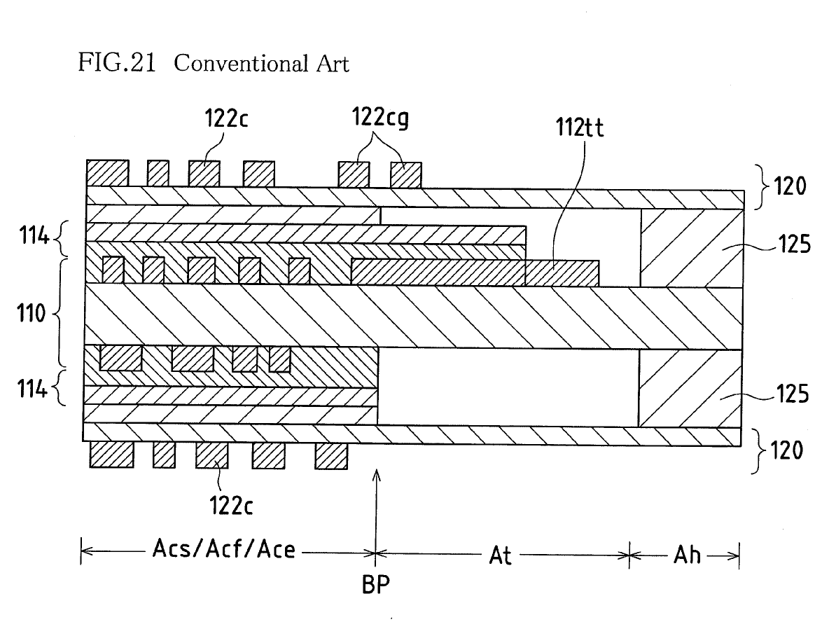

FIG. 22 is a plan view that shows, viewed from above, a state in which a cutting slit has been formed after configuring the outer layer pattern portion in FIG. 21.

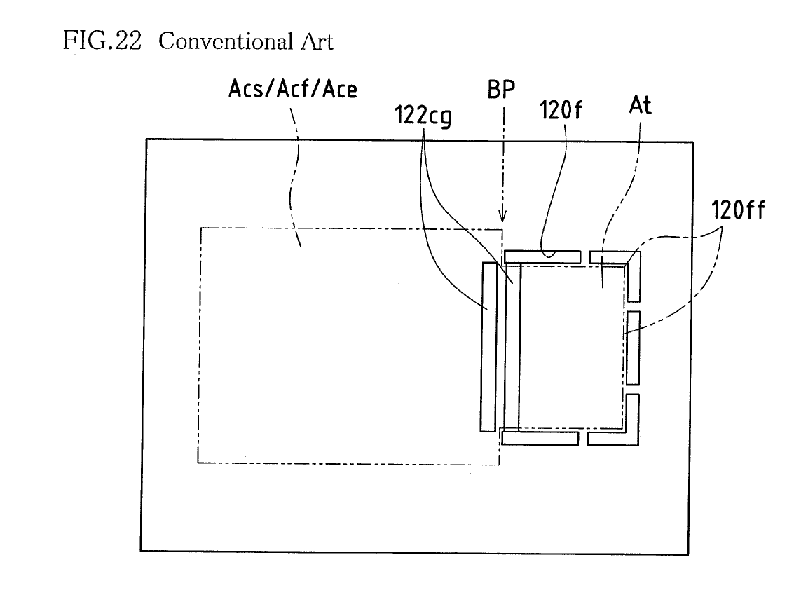

### DESCRIPTION OF THE PREFERRED EMBODIMENTS

Hereinafter, embodiments of the present invention will be described with reference to the accompanying drawings. In order to simplify the description of the following embodiments, an example multilayer printed wiring board is disclosed with a configuration in which a flexible portion (a lead pattern portion) is a single-layer conductor layer, and a multilayer portion (a layered circuit pattern portion) is a four-layer conductor layer, but the layered circuit pattern portion is not limited to being a four-layer conductor layer, and may be a three-layer conductor layer, or may have another multilayer configuration. Also, the following configurations are applicable in any form of multilayer printed wiring board, including a so-called built-up substrate according to a laser method, photo-via method, or the like.

### First Embodiment

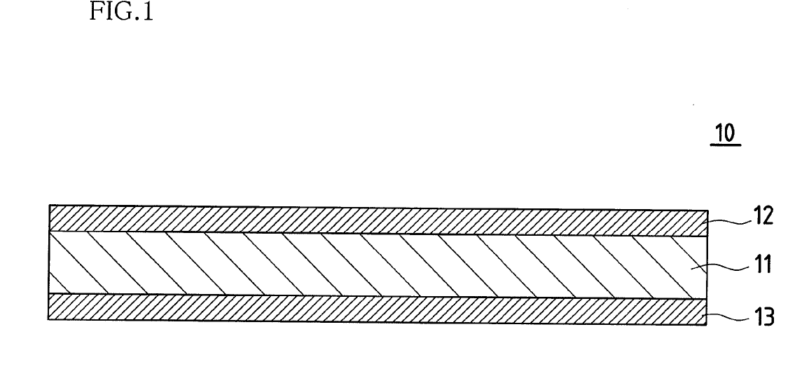

Following is a description of a method for manufacturing a multilayer printed wiring board according to a first embodiment, with reference to FIGS. 1 to 13.

In the first embodiment is described as an example of a multilayer printed wiring board (a so-called flying tail-type) with a form in which a flexible lead pattern portion is extended from approximately the middle in the thickness direction of the layered circuit pattern portion where an inner layer circuit pattern portion and an outer layer circuit pattern portion have been layered.

FIG. 1 is a cross-sectional view that shows the overall configuration of an inner layer base material applied in a method for manufacturing a multilayer printed wiring board according to the first embodiment of the present invention.

An inner layer base material 10 is configured with a flexible inner layer insulating base material 11 that serves as an inner layer core, and conductor layers 12 and 13 formed on both faces of the inner layer insulating base material 11. The inner layer insulating base material 11, for example, is an insulating resin film such as a polyimide, polyether ketone, or crystal polymer. Also, the conductor layers 12 and 13 are formed by layering, for example, a conductor metal (metal layer) such as copper foil on the surfaces of the inner layer insulating base material 11, with interposition of adhesive or without adhesive.

A double-sided flexible multilayer printed wiring board material that is ordinarily commercially available can be employed as the inner layer base material 10. In the first embodiment, for example, the material used has copper foil with a thickness of 12.5 μm to 25 μm layered and fastened to both faces of a polyimide film having a thickness of 25 μm. Accordingly, the inner layer base material 10 is configured to have flexibility as a whole. Also, the material and/or the thickness of the inner layer base material 10 can be appropriately selected according to the specifications required by the flexible portion (lead pattern portion).

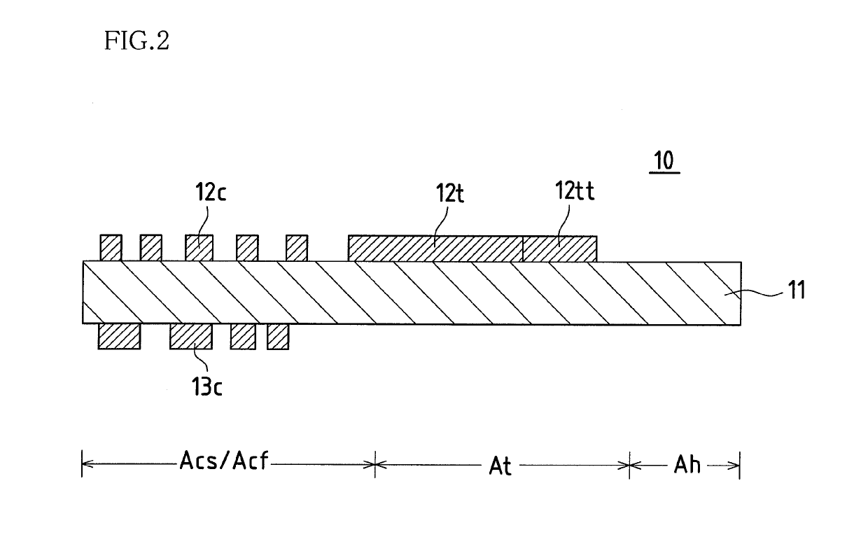

FIG. 2 is a cross-sectional view that shows an overall state in which an inner layer circuit pattern portion and a lead pattern portion have been formed in the inner layer base material shown in FIG. 1.

An etching resist is formed on the surface of the conductor layers 12 and 13 by employing a commonly-known circuit pattern formation method (such as a photolithography method), and by etching (patterning) the conductor layers 12 and 13 with an appropriate etching fluid (for example, such as cupric chloride or ferrous chloride), an inner layer circuit pattern 12c, an inner layer circuit pattern 13c, and a lead pattern 12t are formed.

The inner layer circuit pattern 12c and the inner layer circuit pattern 13c constitute an inner layer circuit pattern portion Acf. The lead pattern 12t constitutes a lead pattern portion At extended from the inner layer circuit pattern portion Acf. That is, by patterning the conductor layers 12 and 13 of the inner layer base material 10, the inner layer circuit pattern portion Acf (inner layer circuit patterns 12c and 13c) and the lead pattern portion At (lead pattern 12t) are formed (inner layer pattern formation step).

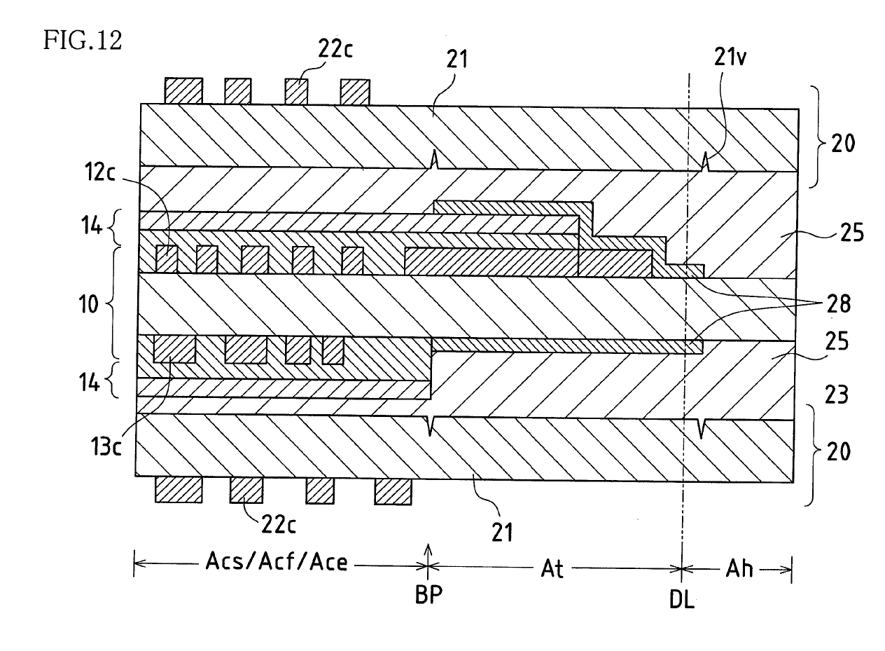

The inner layer circuit pattern portion Acf has a two-layer structure configured with the inner layer circuit patterns 12c and 13c, but may also be configured with a single layer of only the inner layer circuit pattern 12c. Also, in the inner layer circuit pattern portion Acf, an outer layer circuit pattern 22c is formed by layering in a subsequent step, thus configuring a layered circuit pattern portion Acs/outer layer circuit pattern portion Ace (see FIG. 12).

The lead pattern 12t is a lead pattern for making an external connection, and is extended from the inner layer circuit pattern 12c (the inner layer circuit pattern portion Acf). Formed at the tip of the lead pattern 12t is an exposed portion 12tt that acts as a terminal portion/land portion. Also, surface treatment such as gold plating or the like is performed on the exposed portion 12tt in a subsequent step, so that the exposed portion 12tt functions as a connection terminal that is connected to outside. That is, the exposed portion 12tt is a portion drawn out as a connection terminal of the lead pattern portion At of the completed multilayer printed wiring board.

In the first embodiment, the lead pattern portion At is configured having only a single layer of the lead pattern 12t, so the lead pattern extended from the inner layer circuit pattern 13c is not formed.

Also, when an inner via hole that connects the inner layer circuit pattern 12c and the inner layer circuit pattern 13c (or the outer layer circuit pattern 22c described below) to each other is necessary, in the same manner as a conventional method, it is possible to appropriately perform through hole processing, hole filling processing if necessary, or the like.

A discarded plate portion Ah that is ultimately cut away is disposed around the circumference of the inner layer circuit pattern portion Acf (layered circuit pattern portion Acs) and the lead pattern portion At.

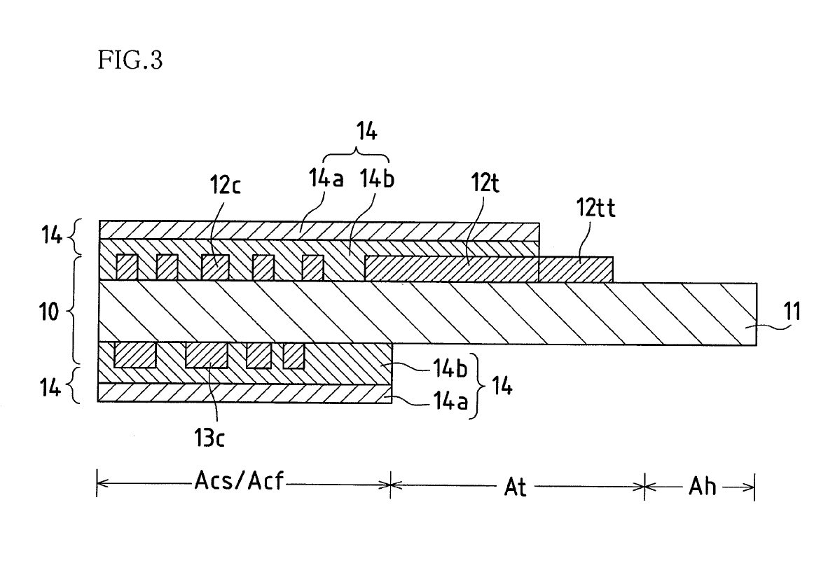

FIG. 3 is a cross-sectional view that shows an overall state in which an insulating protective film has been formed on the inner layer base material shown in FIG. 2.

After the inner layer pattern formation step, a coverlay 14 that serves as an insulating protective film is fastened to conductor layer portions other than the exposed portion 12tt (the inner layer circuit pattern 12c, the inner layer circuit pattern 13c, and the lead pattern 12t). It is desirable to employ the same material as the insulating resin film of the inner layer insulating base material 11, with approximately the same thickness, is used as the coverlay 14.

In the first embodiment, for example, a commercially available coverlay material is used that has a coverlay base material 14a that is a polyimide film with a thickness of 25 μm, same as the inner layer insulating base material 11, and a coverlay adhesive layer 14b formed on one side of the coverlay base material 14a. As described above, the exposed portion 12tt is not covered by the coverlay 14, so that the conductor layer is left exposed.

The coverlay 14 is affixed to the entire surface except for the terminal area (exposed portion 12tt) of the lead pattern portion At, including the inner layer circuit pattern portion Acf. However, a method is also possible in which, with the object of reducing the total thickness of the layered circuit pattern portion Acs, improving the interlayer adhesive properties of the layered circuit pattern portion Acs, and the like, the coverlay 14 is not provided on the layered circuit pattern portion Acs. Also, with the object of increasing reliability of through hole formation between layers, a configuration is also possible in which the coverlay 14 is removed from the area around a through hole.

Next, surface treatment is performed on the exposed portion 12tt, such as gold plating, tin plating, rust-proofing treatment, or the like. For example, when performing gold plating, after performing polishing or soft etching of the surface of the conductor layer, applying a plating resist to a portion where plating is not necessary, and performing pretreatment such as seeding, nickel plating and gold plating are performed in order.

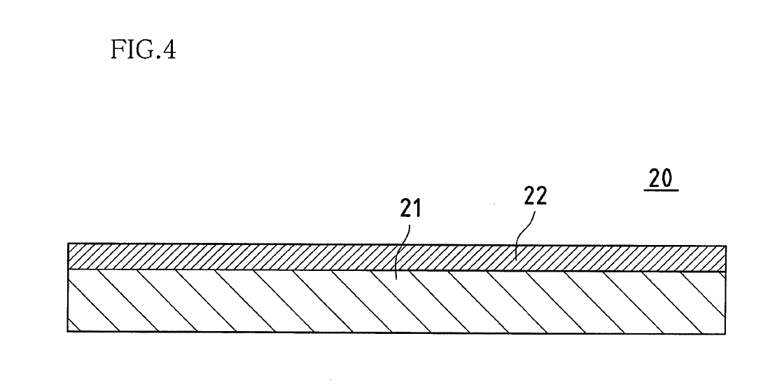

FIG. 4 is a cross-sectional view of the overall state of an outer layer base material prepared for layering on the inner layer base material shown in FIG. 3.

Next, an outer layer base material 20 that will be layered on the inner layer base material 10 is prepared (outer layer base material preparation step). The outer layer base material 20 is configured with an outer layer insulating base material 21 that serves as an outer layer core, and a conductor layer 22 formed on the surface of the outer layer insulating base material 21.

For example, a commercially available single-sided printed wiring board material (single-sided wiring base material), in which copper foil (the conductor layer 22) is layered on a fiberglass reinforced epoxy type resin core material (the outer layer insulating base material 21) with a thickness of 0.1 mm, was used as the outer layer base material 20.

The material and thickness of the outer layer base material 20 (the outer layer insulating base material 21), same as the inner layer base material 10, is not directly related to the configuration of the present invention, and so according to the necessary properties of the multilayer printed wiring board to be manufactured, it is possible to use basically any material that can be used for a multilayer printed wiring board material; for example, paper, polyester reinforced with aramid resin fiber or another fiber, polyether ketone, phenol, fluorocarbon resin, another resin, or the like can be used. Also, when softness such as that of the lead pattern portion At is not required, the outer layer base material can be hard.

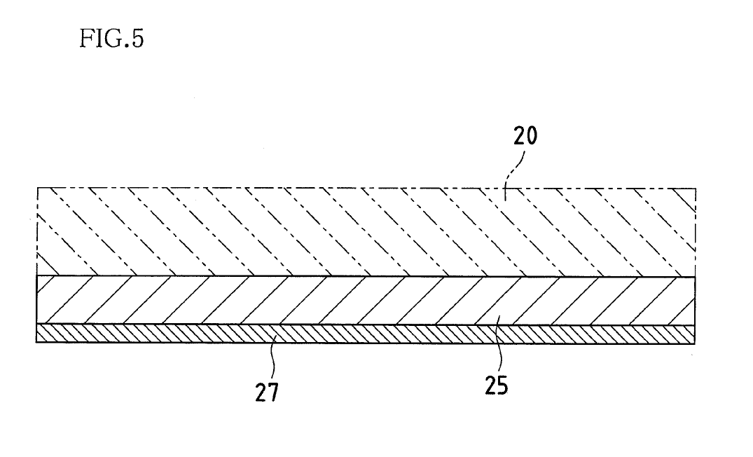

FIG. 5 is a cross-sectional view that shows an overall state of an interlayer adhesive layer prepared as a member that layers the outer layer base material shown in FIG. 4 on the inner layer base material.

An interlayer adhesive layer 25 for fastening the outer layer base material 20 to the inner layer base material 10 are prepared. More specifically, an interlayer adhesive layer 25 is prepared to which an inner layer separation film 27 has been affixed, the inner layer separation film 27 having releasability from the inner layer base material 10 (interlayer adhesive layer preparation step).

A semi-hardened epoxy resin sheet, which is commercially available as a multilayer printed wiring board material in sheet-like form, was used as the interlayer adhesive layer 25. The material quality and thickness of the interlayer adhesive layer 25, same as the outer layer base material 20, may be freely selected as necessary.

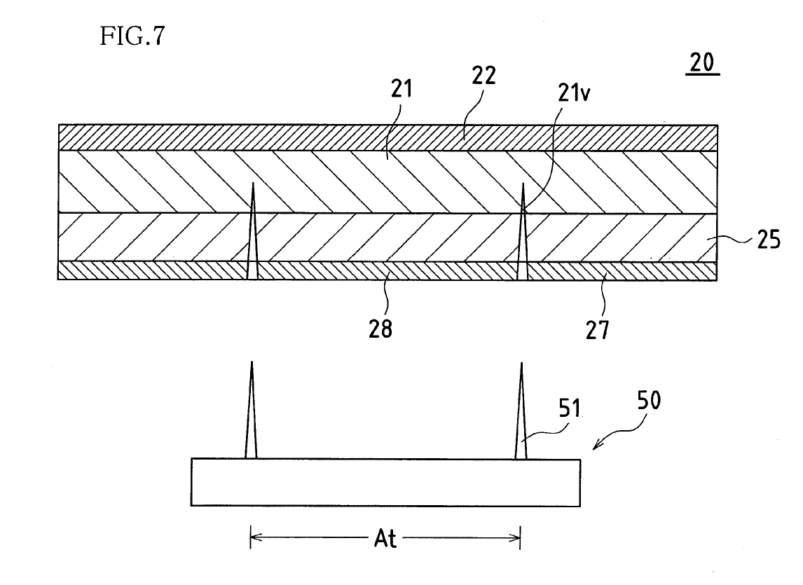

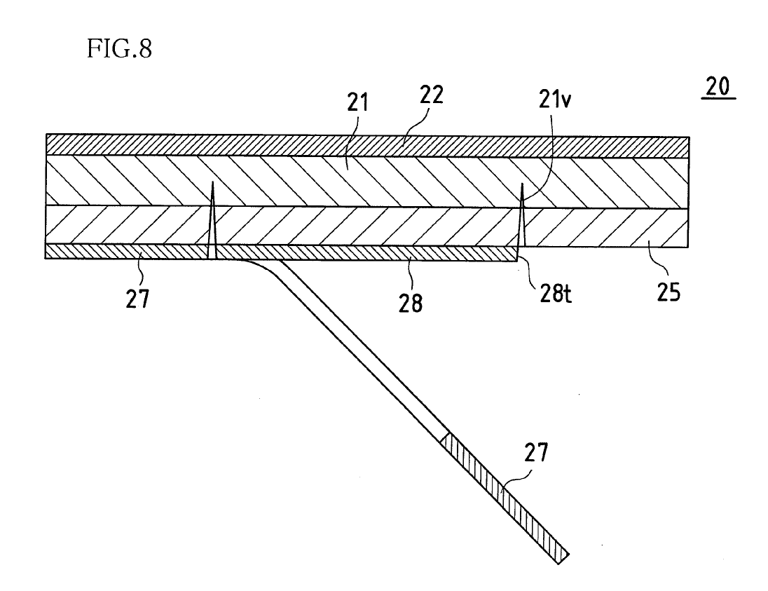

Also, the inner layer separation film 27 having releasability from the inner layer base material 10 is affixed to the interlayer adhesive layer 25 in advance. In other words, it is desirable that the interlayer adhesive layer 25 and the inner layer separation film 27 are in a sheet-like form, layered with each other in advance. With this configuration, the interlayer adhesive layer 25 and the inner layer separation film 27 can be prepared with good productivity and reliability, and molding of the inner layer separation film 27 (see FIGS. 7 and 8) can be easily performed.

Also, affixing of the inner layer separation film 27 to the interlayer adhesive layer 25 can be performed using tackiness of the interlayer adhesive layer 25 (semi-hardened epoxy resin sheet), and so a separate treatment such as pretreatment was not particularly performed on the inner layer separation film 27 itself.

However, for example, when tackiness of the interlayer adhesive layer 25 is stronger than necessary, and so in a subsequent step (separation film molding step of molding the inner layer separation film 27; see FIGS. 7 and 8) it is difficult to peel away unnecessary portions of the inner layer separation film 27 to form a molded inner layer separation film 28 (see FIGS. 7 and 8), it is also possible to perform in advance a mold releasing treatment using silicone resin or the like on the surface of the inner layer separation film 27 (the surface on the side that becomes a border with the interlayer adhesive layer 25).

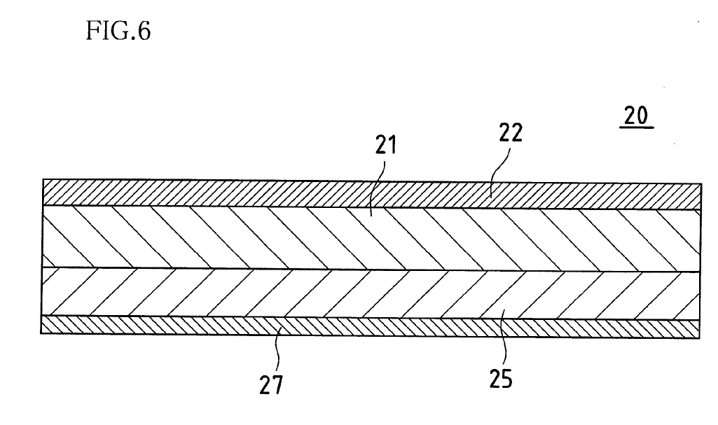

FIG. 6 is a cross-sectional view that shows an overall state in which the outer layer base material shown in FIG. 4 and the interlayer adhesive layer shown in FIG. 5 have been layered.

The interlayer adhesive layer 25, to which the inner layer separation film 27 has been affixed, is layered and formed on the face where the outer layer base material 20 faces the inner layer base material 10 (i.e., the surface of the outer layer insulating base material 21 on the side opposite to the conductor layer 22) (interlayer adhesive layer layering step). More specifically, a layer structure is established that is configured with the outer layer insulating base material 21 and the conductor layer 22 that constitute the outer layer base material 20, the interlayer adhesive layer 25 on which the outer layer insulating base material 21 has been layered, and the inner layer separation film 27 that has been affixed in advance to the interlayer adhesive layer 25. This layer structure is made into a single body by affixing the inner layer separation film 27 to the outer layer base material 20.

The adhesive strength of the interlayer adhesive layer 25 and the outer layer insulating base material 21 in the interlayer adhesive layer layering step is adequate if such that the interlayer adhesive layer 25 and the outer layer insulating base material 21 do not separate from each other in the course of processing, and the adhesive strength that is necessary in a completed state is not necessary here. That is, fastening and layering are performed at a level that can be considered to be temporary.

FIG. 7 is a cross-sectional view of an overall state when the inner layer separation film affixed to the outer layer base material in FIG. 6 is cut so as to correspond to the lead pattern portion. FIG. 8 is a cross-sectional view of an overall state when removing the inner layer separation film other than the molded inner layer separation film formed by cutting the inner layer separation film in FIG. 7.

The inner layer separation film 27 that has been affixed to the entire face of the interlayer adhesive layer 25 is cut with, for example, a knife 50 (blade tip 51) that is a pinnacle-type or Thomson-type knife or the like (FIG. 7). That is, the inner layer separation film 27 is formed by cutting around (the outer circumference of) the lead pattern portion At with the blade tip 51, thus forming the molded inner layer separation film 28 so as to correspond to the lead pattern portion At (separation film molding step).

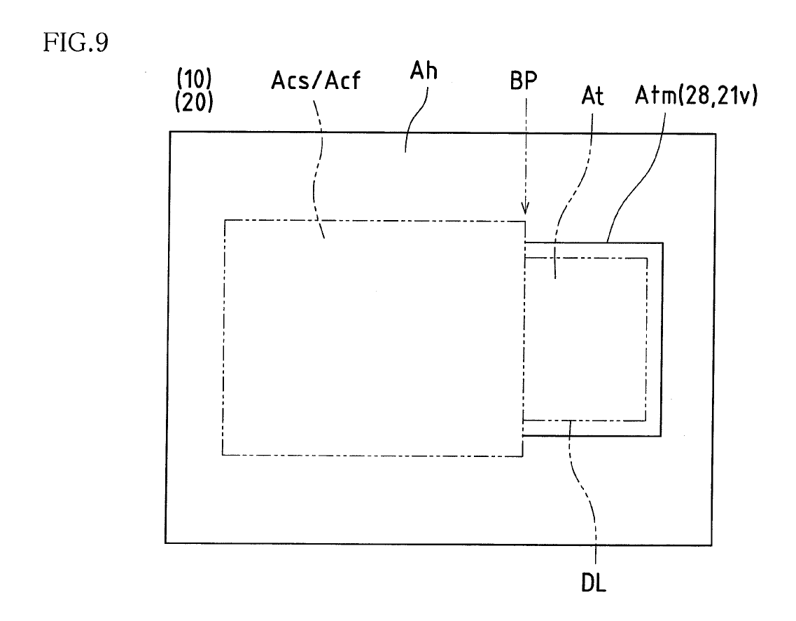

Cut-ins 21v are formed at the border of the inner layer circuit pattern portion Acf and the lead pattern portion At (border position BP; see FIG. 9), and on the outside (excess outer shape Atm) of the outer shape position of the lead pattern portion At other than at the border (cutting line DL; see FIG. 9), and thus the inner layer separation film 27 is formed at the position of the cut-ins 21v.

When cutting the inner layer separation film 27, the cut-ins 21v are formed by cutting the inner layer separation film 27 and the interlayer adhesive layer 25 so as to reach the outer layer base material 20 (the outer layer insulating base material 21), i.e. forming a so-called half-cut. With this configuration, in a state maintaining the outer shape of the outer layer base material 20, the inner layer separation film 27 corresponding to the lead pattern portion At is formed by being separated from the surrounding inner layer separation film 27. Also, the molded inner layer separation film 28 is formed by employing the interlayer adhesive layer 25 to which the inner layer separation film 27 has been affixed, so the molded inner layer separation film 28 can be formed with good productivity, and it is possible to simplify the production process.

In a separation film molding step performed after delineating the molded inner layer separation film 28 by cutting the inner layer separation film 27, the inner layer separation film 27 (the inner layer separation film 27 that becomes unnecessary in a base material layering step described below) other than the molded inner layer separation film 28 is removed (peeled away), leaving as the molded inner layer separation film 28 the inner layer separation film 27 that corresponds to the area of the lead pattern portion At. With this configuration, the molded inner layer separation film 28 corresponding to the lead pattern portion At can be formed easily and precisely and with good productivity.

At a cut edge 28t of the molded inner layer separation film 28, during half-cutting in the separation film molding step, a greater pressure due to pressing of the blade tip 51 than at other temporarily fastened locations is applied, and cutting is performed so as to cut into the interlayer adhesive layer 25, so it is possible to easily remove the unnecessary inner layer separation film 27, while reliably leaving the molded inner layer separation film 28 portion.

Also, as the inner layer separation film 27, it is desirable to employ, for example, a polyimide resin film or the like having a physical property of not discharging soiled matter due to cutting.

FIG. 9 is a plan view that illustrates a planar state of the molded inner layer separation film viewed through the outer layer base material when the outer layer base material with the molded inner layer separation film formed therein is layered on the inner layer base material.

The layered circuit pattern portion Acs (and the outer layer circuit pattern portion Ace described below) is configured corresponding to the inner layer circuit pattern portion Acf by layering the inner layer base material 10 and the outer layer base material 20. Also, the layered circuit pattern portion Acs is disposed in a state in which, for example, the lead pattern portion At protrudes from a border position BP of the inner layer circuit pattern portion Acf and the lead pattern portion At. Note that the discarded plate portion Ah is present at the circumference of the inner layer circuit pattern portion Acf (layered circuit pattern portion Acs) and the lead pattern portion At.

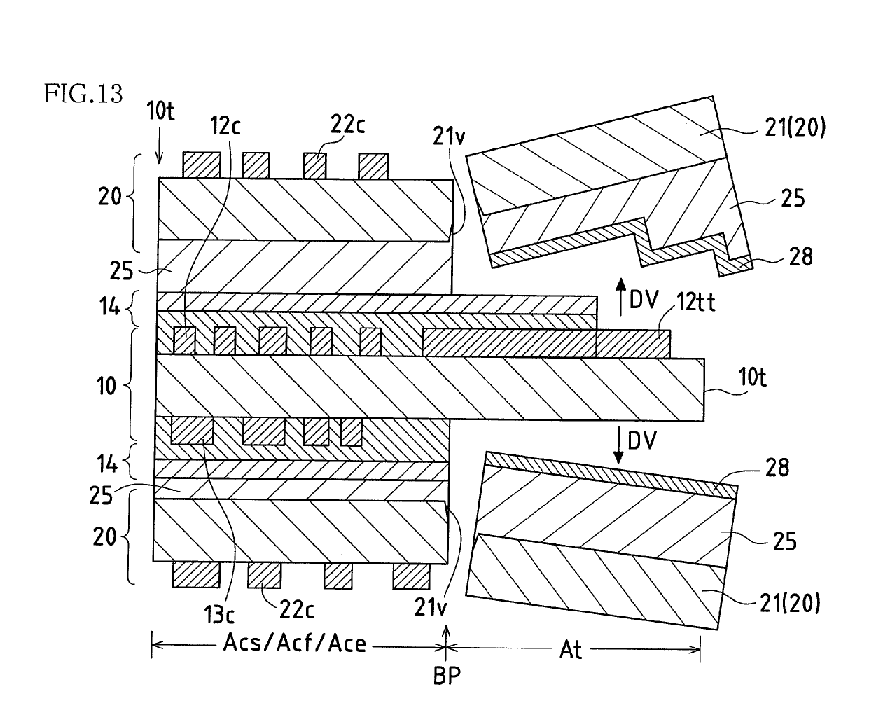

The inner layer circuit pattern portion Acf (the layered circuit pattern portion Acs) and the lead pattern portion At are cut at the cutting line DL except at the border position BP of the inner layer circuit pattern portion Acf and the lead pattern portion At, thus performing outer shape processing (outer shape formation step; see FIGS. 12 and 13).

In consideration of an offset tolerance or the like in the outer shape processing due to the cutting line DL, the outer shape position of the lead pattern At is, other than at the border position BP of the lead pattern portion At and the layered circuit pattern portion Acs, set as an excess outer shape Atm that is slightly larger than the actual outer shape (see FIGS. 12 and 13; outer circumferential edge 10t of the lead pattern portion At; position of cutting line DL).

Accordingly, in order to effect the excess outer shape Atm, the cut-ins 21v, which are formed so as to reach the outer layer base material 20 (the outer layer insulating base material 21) by cutting the inner layer separation film 27 and the interlayer adhesive layer 25 in the separation film molding step, are formed at the border (the border position BP) of the inner layer circuit pattern portion Acf and the lead pattern portion At, and to the outside (for example, the circumference of the excess outer shape Atm) of the outer shape position (the position of the cutting line DL) of the lead pattern portion At other than at the border (the border position BP). Thus the inner layer separation film 27 is formed at the position of the cut-ins 21v.

With this configuration, the molded inner layer separation film 28 corresponding to the lead pattern portion At can be formed precisely, and it is possible to precisely and easily remove the outer layer base material 20 and the interlayer adhesive layer 25. That is, because the molded inner layer separation film 28 can be exposed reliably at the outer circumferential edge 10t (see FIG. 13) formed in the outer shape formation step described below, it is possible for the molded inner layer separation film 28, the interlayer adhesive layer 25 and the outer layer base material 20 to be very easily and precisely separated from the inner layer base material 10. Note that below, simply the lead pattern portion At is described, without distinguishing the excess outer shape Atm.

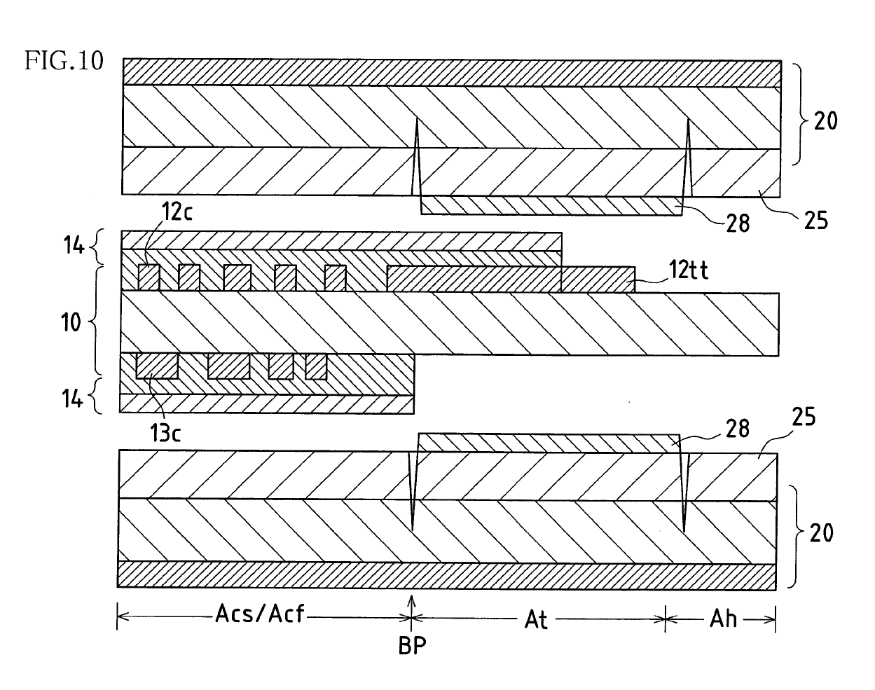

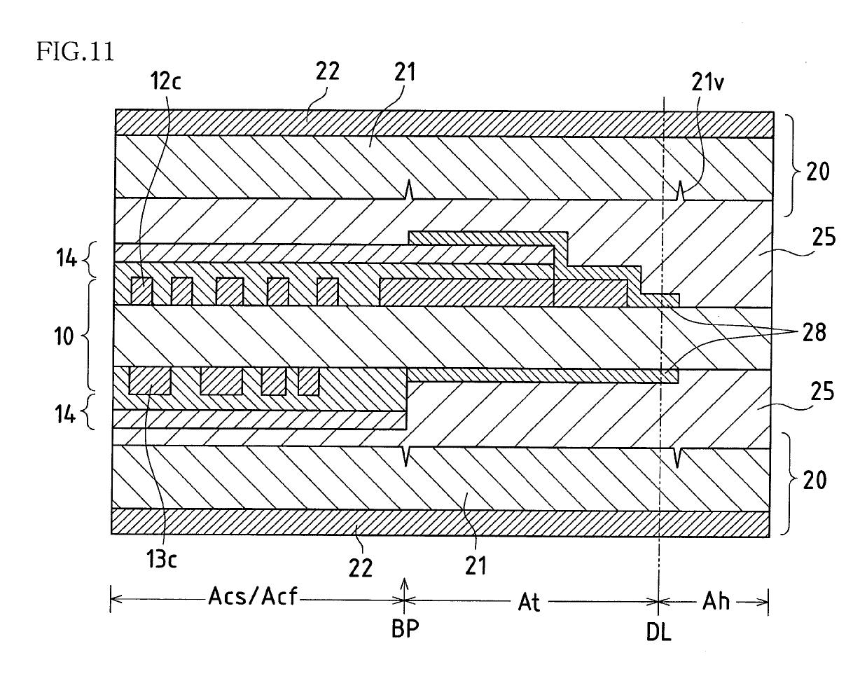

FIG. 10 is a cross-sectional view of an overall arranged state when the outer layer base material with the molded inner layer separation film formed therein has been positioned on the inner layer base material. FIG. 11 is a cross-sectional view that shows an overall state in which after the positioning in FIG. 10, the outer layer base material has been layered on the inner layer base material.

The molded inner layer separation film 28 is positioned on the lead pattern portion At, and the outer layer base material 20 is layered on the inner layer base material 10 with interposition of the interlayer adhesive layer 25 (base material layering step). The molded inner layer separation film 28 is disposed so as to reach the outside (the discarded plate portion Ah) of the lead pattern portion At (outer shape position) at a position other than the border position BP, and covers the surface of the interlayer adhesive layer 25, so it is possible to adopt a configuration in which when the inner layer base material 10 and the outer layer base material 20 are layered, the lead pattern portion At (the conductor layer 12t) of the inner layer base material 10 is not fastened to the outer layer base material 20 and the interlayer adhesive layer 25.

With this configuration, it is possible to layer the inner layer base material 10 and the outer layer base material 20 with uniform pressure and good flatness, in a state with the lead pattern portion At separated from the interlayer adhesive layer 25 and the outer layer base material 20, and thus it is possible to configure the lead pattern portion At precisely and with good productivity.

Also, as described above, it is desirable that the molded inner layer separation film 28 has a physical property of maintaining releasability as the inner layer separation film 27 in a heated state in the interlayer adhesive layer layering step, the base material layering step, and an outer layer pattern formation step described below.

Also, in order to perform a stable base material layering step in which a height difference due to the thickness of the molded inner layer separation film 28 is absorbed, and the outer layer base material 20 and the inner layer base material 10 are layered by applying equal pressure, it is desirable that the molded inner layer separation film 28 is thinner than the interlayer adhesive layer 25.

Also, the molded inner layer separation film 28, requires properties such as maintaining shape and physical properties against temperature and pressure in the base material layering step as described above, excess gas or soiled matter not being discharged when performing layer fastening, not reacting with the coverlay 14 or the exposed portion 12tt of the lead pattern portion At, and not fastening to or depositing on the inner layer base material 10 and the coverlay 14.

Also, as described above, it is desirable that the molded inner layer separation film 28 is provided with a surface having affixing properties (tackiness, stickiness, adhesiveness, or the like) of a level required for a material that releases from the interlayer adhesive layer 25, and that the physical properties of the molded inner layer separation film 28 do not change in the interlayer adhesive layer layering step, the base material layering step, and the outer layer pattern formation step. Accordingly, because the heating temperature in the base material layering step in which the interlayer adhesive layer 25 constituted of epoxy type resin is applied is about 200° C., in consideration of heat resistance, polyimide resin (film) was applied as material that maintains the above properties. With this configuration, it is possible to adopt an inner layer separation film 27 (molded inner layer separation film 28) that exhibits stable action.

The inner layer separation film (the molded inner layer separation film 28) can be selected according to the adhesive used as the interlayer adhesive layer 25 and the adhesive hardening conditions. For example, it is possible to use polyether ketone, polycarbonate, or the like, or it is possible to use polyester, polyethylene terephthalate, fluorocarbon resin, or the like.

Layering and fastening are performed with the outer layer base material 20 disposed facing the inner layer base material 10 on both sides of the inner layer base material 10, so that the layered circuit pattern portion Acs has a four-layer structure.

In the first embodiment, the layered state of the lead pattern portion At is a state in which a space is not produced, as in the layered state of the layered circuit pattern portion Acs. That is, because a space is not produced between the lead pattern portion At and the layered circuit pattern portion Acs, unlike with the conventional technology, a difference in height between the lead pattern portion At and the layered circuit pattern portion Acs is greatly suppressed.

That is, because incontinuity of thickness between the lead pattern portion At and the layered circuit pattern portion Acs is eliminated, in the lead pattern portion At and the layered circuit pattern portion Acs, regardless of their respective regions, the outer layer base material 20 is uniformly pressed against the inner layer base material 10, and so there is no risk of distortion due to uneven pressure on the lead pattern portion At.

That is, the difference in thickness (height difference) of the layered materials between the layered circuit pattern portion Acs and the lead pattern portion At does not exceed the thickness of one sheet of the molded inner layer separation film 28, and specifically can be at most from several μm to several tens of μm. Also, the interlayer adhesive layer 25, which has fluidity, is filled between the inner layer base material 10 and the outer layer base material 20, so even the difference in height described above can be absorbed by the flow of the interlayer adhesive layer 25 during layering.

Accordingly, there is no risk of damage to the lead pattern portion At due to a difference in height between the lead pattern portion At and the layered circuit pattern portion Acs, and so it is possible to greatly improve the anti-flexibility properties of the lead pattern portion At the border position BP.

Further, because the molded inner layer separation film 28 is closely fitted to the lead pattern portion At (the inner layer base material 10) in a state having releasability during layering, a gap does not occur due to a difference in the number of layers as with the conventional technology, and so a phenomenon of fastening due to the interlayer adhesive layer 25 flowing and protruding out to the lead pattern portion At, which causes defective goods, does not occur. That is, because the interlayer adhesive layer 25 does not protrude to an unintended portion to cause defects, it is possible to improve product quality/step yield.

FIG. 12 is a cross-sectional view that shows an overall state in which a layered circuit pattern portion has been configured by forming an outer layer circuit pattern on the outer layer base material layered on the inner layer base material in FIG. 11.

After layering is finished, through hole processing/via hole processing (not shown) and outer layer patterning are performed with a procedure like that used in a conventional method. By performing outer layer patterning, the conductor layer 22 of the outer layer base material 20 layered on the inner layer base material 10 is patterned to form outer layer circuit patterns 22c that correspond respectively to the inner layer circuit pattern 12c and the inner layer circuit pattern 13c. The outer layer circuit patterns 22c constitute the outer layer circuit pattern portion Ace. That is, the conductor layer 22 of the outer layer base material 20 is patterned to form the outer layer circuit pattern portion Ace corresponding to the inner layer circuit pattern portion Acf (outer layer pattern formation step).

After the outer layer pattern formation step, necessary processing treatment is performed, such as surface treatment like plating, rust-proofing treatment, and the like, solder resist treatment, silk printing treatment, and the like.

After necessary processing treatment, the layered circuit pattern portion Acs constituted by the inner layer circuit pattern portion Acf and the outer layer circuit pattern portion Ace, and the lead pattern portion At, are cut from the discarded plate portion Ah (the surrounding inner layer base material 10 and outer layer base material 20) at the cutting line DL, thus forming the outer circumferential edge 10t of the layered circuit pattern portion Acs and the lead pattern portion At (outer shape; see FIG. 13). That is, the outer shape (the outer circumferential edge 10t) of the lead pattern portion At is formed by cutting the layered inner layer base material 10 and the outer layer base material 20 at the outer shape position (cutting line DL) of the lead pattern portion At (outer shape formation step).

With this configuration, the molded inner layer separation film 28 is exposed to the edge portion (the outer circumferential edge 10t) of the outer shape, and because the exposed molded inner layer separation film 28 can be easily peeled away from the lead pattern portion At, it is possible to form a lead pattern portion precisely and with good productivity.

FIG. 13 is a cross-sectional view that shows an overall state in which a multilayer printed wiring board is completed by forming outer circumferential edges of the layered circuit pattern portion and the lead pattern portion in FIG. 12, and then separating the outer layer base material that corresponds to the lead pattern portion from the inner layer base material.

After cutting from the surrounding inner layer base material 10 and outer layer base material 20 (discarded plate portion Ah) at the cutting line DL to form the outer circumferential edge 10t of the layered circuit pattern portion Acs and the lead pattern portion At (outer shape forming step), the molded inner layer separation film 28 is separated (peeled away) from the inner layer base material 10, and thus the interlayer adhesive layer 25 and the outer layer base material 20 (the outer layer insulating base material 21) layered on the molded inner layer separation film 28 are removed (outer layer base material removal step).

In the lead pattern portion At, the molded inner layer separation film 28 disposed corresponding to the lead pattern portion At is layered, and so affixing with the outer layer base material 20 to the inner layer base material 10 does not occur. Accordingly, when the outer layer base material 20 is peeled away from the outer circumferential edge 10t, where the molded inner layer separation film 28 was exposed, in the direction indicated by arrow DV, it is possible to separate the molded inner layer separation film 28, the interlayer adhesive layer 25, and the outer layer insulating base material 21 (outer layer base material 20) from the lead pattern portion At.

Also, there is incontinuity of adhesive strength between the inner layer base material 10 and the outer layer base material 20 at the border position BP of the layered circuit pattern portion Acs and the lead pattern portion At. That is, there is adequate strength on the layered circuit pattern portion Acs side because the inner layer base material 10 and the outer layer base material 20 are fastened by the interlayer adhesive layer 25, but on the lead pattern portion At side, there is almost no adhesive strength between the inner layer base material 10 and the outer layer base material 20 due to the presence of the molded inner layer separation film 28.

Accordingly, the outer layer base material 20 is easily folded at the border position BP and removed from the lead pattern portion At (inner layer base material 10) (outer layer base material removal step), and thus the multilayer printed wiring board according to the first embodiment is completed.

Also, at the border position BP of the lead pattern portion At and the layered circuit pattern portion Acs, the outer layer base material 20 (outer layer insulating base material 21) was half-cut as the cut-ins 21v when the molded inner layer separation film 28 was formed, and the cut-ins 21v operate as so-called V-notches. Accordingly, in the outer layer base material removal step, when the molded inner layer separation film 28 (and the outer layer base material 20) is peeled, the outer layer base material 20 is automatically folded at the cut-ins 21v, so that it is possible to easily and cleanly remove the outer layer base material 20.

That is, it is possible to form a clean cutting face that corresponds to the cut-ins 21v at the border (the border position BP) of the inner layer circuit pattern portion Acf and the lead pattern portion At, and precisely and easily remove the molded inner layer separation film 28, the interlayer adhesive layer 25, and the outer layer base material 20, thus precisely forming a lead pattern portion At with strong connecting strength.

After exposing the molded inner layer separation film 28 at the outer circumferential edge 10t in the outer shape formation step by cutting at the cutting line DL, the molded inner layer separation film 28 and the outer layer base material 20 corresponding to the molded inner layer separation film 28 are removed in the outer layer base material removal step, so it is possible to very easily remove the outer layer base material 20 from the inner layer base material 10 (the lead pattern portion At).

As the outer shape processing, other than the method shown in FIGS. 8 and 9 (forming the outer circumferential edge 10t in the outer shape formation step, and then removing the outer layer base material 20 in the outer layer base material removal step), it is possible to perform middle hole processing that temporarily cuts only the outer layer base material 20 corresponding to an outline portion of the lead pattern portion At when viewed from above with a die, router (channel cutting device), or the like, and remove the outer layer base material 20 corresponding to the lead pattern portion At (outer layer base material removal step), and then perform outer shape processing (outer shape formation step) that forms the outer circumferential edge 10t. With this configuration, it is possible to form the outer circumferential edge 10t corresponding to the lead pattern portion At cleanly and precisely.

As described above, the method for manufacturing a multilayer printed wiring board according to the first embodiment is a method for manufacturing a multilayer printed wiring board provided with a flexible inner layer base material 10 having an inner layer circuit pattern portion Acf and a lead pattern portion At extended from the inner layer circuit pattern portion Acf, and an outer layer base material 20 having an outer layer circuit pattern portion Ace layered on the inner layer circuit pattern portion Acf; the method being provided with an inner layer pattern formation step of patterning a conductor layer 12 (13) of the inner layer base material 10 to form the inner layer circuit pattern portion Acf and the lead pattern portion At, an outer layer base material preparation step of preparing the outer layer base material 20 that will be layered on the inner layer base material 10, an interlayer adhesive layer preparation step of preparing an interlayer adhesive layer 25 to which has been affixed an inner layer separation film 27 that has releasability from the inner layer base material 10, an interlayer adhesive layer layering step of layering the interlayer adhesive layer 25 on the outer layer base material 20, a separation film molding step of forming a molded inner layer separation film 28 by molding the inner layer separation film 27 so as to correspond to the lead pattern portion At, a base material layering step of positioning the molded inner layer separation film 28 on the lead pattern portion At and layering the outer layer base material 20 on the inner layer base material 10 with interposition of the interlayer adhesive layer 25, an outer layer pattern formation step of patterning a conductor layer 22 of the outer layer base material 20 layered on the inner layer base material 10 to form the outer layer circuit pattern portion Ace layered corresponding to the inner layer circuit pattern portion Acf, and an outer layer base material removal step of separating the molded inner layer separation film 28 from the inner layer base material 10 to remove the interlayer adhesive layer 25 and the outer layer base material 20 layered on the molded inner layer separation film 28.

With this configuration, the outer layer base material 20, to which is affixed the molded inner layer separation film 28 formed corresponding to the lead pattern portion At, is layered on the inner layer base material 10, so the interlayer adhesive layer 25 and the outer layer base material 20 are prevented from being fastened to the interlayer base material 10 at the lead pattern portion At. Thus it is possible to remove the inner layer separation film 27 (the molded inner layer separation film 28) corresponding to the lead pattern portion At from the inner layer base material 10, and so it is possible to easily and precisely remove the interlayer adhesive layer 25 and the outer layer base material 20 layered on the molded inner layer separation film 28.

That is, even if the interlayer adhesive layer 25 and the outer layer base material 20 are not processed in advance, processing defects such as damage to the lead pattern portion At or protrusion of the adhesive from the interlayer adhesive layer 25 are eliminated, so the border of the layered circuit pattern portion Acs and the lead pattern portion At is formed as a clean and distortion-free cutting face. Thus, effects on the lead pattern portion At in the base material layering step or the outer layer base material removal step by the outer layer base material 20 or the interlayer adhesive layer 25 are eliminated, so the precisely positioned lead pattern portion At can be configured with good productivity, and thus it is possible to manufacture, with good productivity, a multilayer printed wiring board having a lead pattern portion At with high precision and high bendability.

Also, the molded inner layer separation film 28 is formed by molding the inner layer separation film 27 to which the interlayer adhesive layer 25 has been affixed in advance, so a molded inner layer separation film can be formed with good productivity, and it is possible to simplify the production process.

Further, because the cut-ins 21v are formed in the outer layer base material 20, folding of the outer layer base material 20 corresponding to the lead pattern portion At is easy, and the cut shape at the border of the lead pattern portion At and the layered circuit pattern portion Acs is cleanly finished. Also, it is not necessary to use double-sided printed wiring board material (double-sided wiring base material) as the outer layer base material 20, and it is also unnecessary to have an etching step for the inner layer side, so it is possible to simplify the outer layer base material 20.

As described above, in the first embodiment, it is not necessary to perform slit processing/hole processing in advance on the outer layer base material 20 and the interlayer adhesive layer 25, so processing steps can be simplified, and height differences due to processing do not occur, so an effect is obtained that it is possible to prevent processing defects such as damage to the lead pattern portion At or protrusion of the adhesive from the interlayer adhesive layer 25.

Also, effects are obtained that problems such as soiling or affixing of foreign matter by the adhesive (the interlayer adhesive layer 25) do not occur, and a maintenance step is not necessary for the adhesive (the interlayer adhesive layer 25) processing die, and positioning of the interlayer adhesive layer 25 and the outer layer base material 20 relative to the inner layer base material 10 when performing layering becomes easy.

### Second Embodiment

Another example of the inner layer separation film 27 (the molded inner layer separation film 28) in the first embodiment will be described as a second embodiment. Because the basic configuration of the second embodiment is the same as that of the first embodiment, the first embodiment will be cited as appropriate (not shown in the drawings). Mainly aspects of the configuration that differ from the first embodiment will be described.

In the second embodiment, a configuration is adopted in which when the interlayer adhesive layer 25 is supplied in the form of an adhesive sheet, a mold releasing film (mold releasing material) formed in advance on the surface of the adhesive sheet in order to protect the adhesive sheet in the course of transport is applied as-is as the inner layer separation film 27.

That is, the interlayer adhesive layer 25 has the form of an adhesive sheet in advance, and the inner layer separation film 27 is a mold releasing material (mold releasing layer) that has been formed (affixed) in advance on the surface of the interlayer adhesive layer 25 in order to protect the surface of the adhesive sheet (the interlayer adhesive layer 25) in the course of transport. With this configuration, steps are simplified, so it is possible to form the molded inner layer separation film 28 (see FIGS. 7 and 8) with good productivity.

The adhesive sheet in the form applied in the interlayer adhesive layer 25, ordinarily with an object such as preventing soiling of the adhesive face (surface protection), is supplied from the adhesive sheet manufacturer in a form in which a mold releasing film has been affixed to the surface. If the mold releasing film on one face of the purchased adhesive sheet is peeled away and (temporarily) layered on the outer layer base material 20, the state shown in FIG. 6 of the first embodiment is obtained (interlayer adhesive layer layering step). Subsequent steps are the same as in the first embodiment, and so a description thereof is omitted here.

In the second embodiment as well, in which mold releasing film of an adhesive sheet is employed, it is necessary that the mold releasing film (mold releasing material), same as the inner layer separation film 27 described in the first embodiment, satisfies physical properties and other specifications.

When the adhesive sheet and the mold releasing film are used as the interlayer adhesive layer 25 and the inner layer separation film 27 (the molded inner layer separation film 28), it is not absolutely necessary that under the environment of pressure, heating, and the like in the base material layering step in which the outer layer base material 20 is layered and the subsequent outer layer pattern formation step and the like, the mold releasing properties of the mold releasing film are maintained. For example, in the base material layering step of the outer layer base material 20, the mold releasing film may be fastened completely to the adhesive sheet.

That is, it is sufficient that the mold releasing film exhibit a function of preventing the outer layer base material 20 from being fastened to the lead pattern portion At. In other words, when removing the outer layer base material 20 that corresponds to the lead pattern portion At, removal from the surface of the lead pattern portion At may be performed together or separately (it is sufficient to have releasability from the inner layer base material 10), and there is no problem regardless of whether or not fastening occurs, and no problem with respect to adhesive strength.

Also, in actuality, in the case shown in FIG. 11, the inner layer separation film 27 (molded inner layer separation film 28) is completely fastened to the interlayer adhesive layer 25, and when the outer layer base material 20 (the outer layer insulating base material 21) is peeled away, it is possible to simplify the steps if it is also possible to peel away the molded inner layer separation film 28 at the same time as (together with) the outer layer base material 20, and thus it is possible to reduce labor, so such a configuration is desirable.

Also, same as in the case of the first embodiment, when the adhesive sheet (the interlayer adhesive layer 25) is for example constituted of epoxy type resin, it is desirable to employ polyimide resin film as the mold releasing film (mold releasing material). As for selection of material, specifications for physical properties, and the like, it is necessary to satisfy the same physical properties as in the case of the first embodiment.

### Third Embodiment

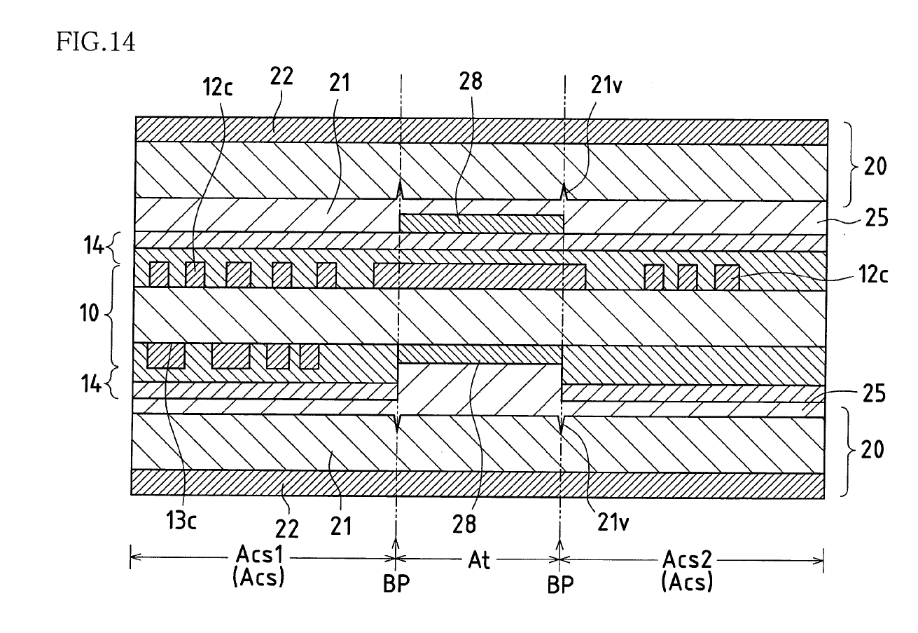

A method for manufacturing a multilayer printed wiring board according to a third embodiment will be described with reference to FIG. 14.

FIG. 14 is a cross-sectional view that shows an overall state in which the molded inner layer separation film according to the first embodiment is applied to a folding-type multilayer printed wiring board, in a method for manufacturing a multilayer printed wiring board according to a third embodiment of the present invention.

The method for manufacturing a multilayer printed wiring board according to the third embodiment is basically the same as in the first embodiment, but differs in that this method is applied to a multilayer printed wiring board (common name: folding-type multilayer printed wiring board) in which a plurality of layered circuit pattern portions Acs (a layered circuit pattern portion Acs1 and a layered circuit pattern portion Acs2; when not necessary to distinguish these, referred to as a layered circuit pattern portion Acs) are connected and linked by the lead pattern portion At. Below, mainly differing points will be described while appropriately citing the reference numerals of the first embodiment. It is also possible to apply the second embodiment.

The basic steps are the same as in the first embodiment. The state shown in FIG. 14 is established by the base material layering step. Because the layered circuit pattern portion Acs1 and the layered circuit pattern portion Acs2 are connected to each other in the lead pattern portion At, a border position BP is formed at two locations corresponding respectively to both edges of the lead pattern portion At. Cut-ins 21v are formed corresponding to the border positions BP.

After the base material layering step, same as in the first embodiment, through the outer layer pattern formation step, at a portion other than the border position BP of the layered circuit pattern portion Acs and the lead pattern portion At, the layered circuit pattern portion Acs and the lead pattern portion At are cut from the surrounding inner layer base material 10 and the outer layer base material 20 to form the outer circumferential edge 10t of the layered circuit pattern portion Acs and the lead pattern portion At (in FIG. 14, disposed on the front side of the drawing and on the rear side toward the paper face) (outer circumferential edge formation step).

After the outer circumferential edge formation step, in the outer layer base material 20, a portion that corresponds to the lead pattern portion At is folded up and removed using the cut-ins 21v (outer layer base material removal step). Accordingly, the outer layer base material 20 is easily folded at the border position BP and removed from the lead pattern portion At (inner layer base material 10), and thus the multilayer printed wiring board according to the third embodiment is completed (outer layer base material removal step).

Also, the outer shape formation step and the outer layer base material removal step in the third embodiment can be the same as steps in the first embodiment.

The same working effects are obtained in the third embodiment as in the first and second embodiments. Also, the uses (scope of applicability) of the multilayer printed wiring board can be expanded.

The present invention may be embodied in various other forms without departing from the gist or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. A method for manufacturing a multilayer printed wiring board, the multilayer printed wiring board being provided with a flexible inner layer base material having an inner layer circuit pattern portion and a lead pattern portion extended from the inner layer circuit pattern portion, and an outer layer base material having an outer layer circuit pattern portion layered on the inner layer circuit pattern portion, the method comprising:
an inner layer pattern formation step of patterning a conductor layer of the inner layer base material to form an inner layer circuit pattern of the inner layer circuit pattern portion and a lead pattern of the lead pattern portion,
an outer layer base material preparation step of preparing the outer layer base material that will be layered on the inner layer base material,
an interlayer adhesive layer preparation step of preparing an interlayer adhesive layer to which has been affixed in advance an inner layer separation film that has releasability from the inner layer base material,
an interlayer adhesive layer layering step of layering the interlayer adhesive layer on the outer layer base material,
a separation film molding step of forming a molded inner layer separation film by molding the inner layer separation film so as to correspond to the lead pattern portion,
a base material layering step of positioning the molded inner layer separation film on the lead pattern portion and layering the outer layer base material on the inner layer base material with interposition of the interlayer adhesive layer,
an outer layer pattern formation step of patterning a conductor layer of the outer layer base material layered on the inner layer base material to form the outer layer circuit pattern portion layered corresponding to the inner layer circuit pattern portion, and
an outer layer base material removal step of separating the molded inner layer separation film from the inner layer base material to remove the interlayer adhesive layer and the outer layer base material layered on the molded inner layer separation film.

2. The method for manufacturing a multilayer printed wiring board according to claim 1, wherein in the separation film molding step, the inner layer separation film other than the molded inner layer separation film is removed.

3. The method for manufacturing a multilayer printed wiring board according to claim 1 or 2, wherein the molded inner layer separation film is thinner than the interlayer adhesive layer, and has physical properties so as to maintain the releasability in the interlayer adhesive layer layering step, the base material layering step, and the outer layer pattern formation step.

4. The method for manufacturing a multilayer printed wiring board according to claim 1 or 2, wherein the interlayer adhesive layer and the inner layer separation film are in a sheet-like form layered with each other in advance.

5. The method for manufacturing a multilayer printed wiring board according to claim 4, wherein the interlayer adhesive layer is in a form of an adhesive sheet in advance, and the inner layer separation film is a mold releasing material formed in advance on the surface of the adhesive sheet in order to protect the surface of the adhesive sheet in a course of transport.

6. The method for manufacturing a multilayer printed wiring board according to claim 2, wherein in the separation film molding step, by cutting the inner layer separation film and the interlayer adhesive layer, a cut-in that reaches the outer layer base material is formed at a border of the inner layer circuit pattern portion and the lead pattern portion, and to the outside of an outer shape position of the lead pattern portion other than at the border, and the inner layer separation film is molded at the position of the cut-in.

7. The method for manufacturing a multilayer printed wiring board according to claim 6, comprising an outer shape formation step of cutting, at the outer shape position of the lead pattern portion, the inner layer base material and the outer layer base material that have been layered, to form the outer shape of the lead pattern portion.

8. The method for manufacturing a multilayer printed wiring board according to claim 6 or 7, wherein the outer layer base material is broken off at the position of the cut-in of the border.

9. The method for manufacturing a multilayer printed wiring board according to claim 1 or 2, wherein the interlayer adhesive layer comprises epoxy type resin, and the inner layer separation film comprises polyimide resin.
